(19) United States
(12) Patent Application Publication
(10) Pub. No.: US 2020/0171962 A1
(43) Pub. Date: Jun. 4, 2020

(54) VEHICLE AND METHOD FOR CONTROLLING THE SAME

(71) Applicants: Hyundai Motor Company, Seoul (KR); Kia Motors Corporation, Seoul (KR)

(72) Inventors: Hoon HAN, Hwaseong-si (KR); Kwonchae CHUNG, Seoul (KR); Jae Young CHOI, Seoul (KR); II Kwon PARK, Seoul (KR)

(73) Assignees: Hyundai Motor Company, Seoul (KR); Kia Motors Corporation, Seoul (KR)

(21) Appl. No.: 16/376,000

(22) Filed: Apr. 5, 2019

(30) Foreign Application Priority Data
Dec. 4, 2018 (KR) 10-2018-0154512

(51) Int. Cl. B60L 15/20; B60W 10/06; B60W 10/08

(52) U.S. Cl. CPC B60L 15/2054; B60W 10/06; B60L 2240/12; B60W 2720/106; B60W 2520/105; B60W 10/08

(57) ABSTRACT

A vehicle and a method for controlling the same are provided to provide consistent deceleration feeling or acceleration feeling during creep driving even when the driving load of the vehicle is changed by determining a creep torque based on a target acceleration of a vehicle, may include a motor; a transmission; a vehicle speed sensor configured to detect a speed of the vehicle; and a controller configured to determine a target acceleration and a creep torque based on a current speed of the vehicle and a gear ratio of the transmission when the vehicle satisfies a creep driving condition, update the determined creep torque based on a difference value between a target speed according to the determined target acceleration and the current speed of the vehicle, and control the motor to transmit the updated creep torque to wheels of the vehicle.

### CROSS-REFERENCE TO RELATED APPLICATION(S)

The present application claims priority to Korean Patent Application No. 10-2018-0154512, filed on Dec. 4, 2018, the entire contents of which is incorporated herein for all purposes by this reference.

### BACKGROUND OF THE INVENTION

### Field of the Invention

The present invention relates to an eco-friendly vehicle which may be driven by the power of a motor, and a method for controlling the same.

### Description of Related Art

Differently from conventional engine-driven vehicles, an electric vehicle (EV), a hybrid electric vehicle (HEV), and a fuel cell vehicle, which are eco-friendly vehicles, are driven by the power of a motor.

In the engine-driven vehicles, an idle torque of an engine is transmitted to a torque converter and a transmission even when an accelerator pedal and a brake pedal are not pressed while driving. Therefore, creep driving is accelerated to a constant speed at a low speed and gradually decelerated at a high speed.

Creep driving is a natural phenomenon without special control when the engine of the engine-driven vehicles is in operation. In contrast, natural creep driving may not be possible in the eco-friendly vehicles which may be driven by the power of the motor.

Therefore, in the eco-friendly vehicles, the motor is controlled so that a torque, which is called a creep torque, is outputted to each wheel when the accelerator pedal and the brake pedal are not pressed to generate a driving feeling similar to the creep driving of the engine-driven vehicles.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a vehicle for providing a consistent deceleration feeling or acceleration feeling during creep driving even when the driving load of the vehicle is changed by determining a creep torque based on a target acceleration of the vehicle, and a method for controlling the same.

Additional aspects of the disclosure will be set forth in part in the description which follows and, in part, will be obvious from the description, or may be learned by practice of the disclosure.

In accordance with an aspect of the present invention, a vehicle may include: a motor; a transmission; a vehicle speed sensor configured to detect a speed of the vehicle; and a controller configured to determine a target acceleration and a creep torque based on a current speed of the vehicle and a gear ratio of the transmission when the vehicle satisfies a creep driving condition, update the determined creep torque based on a difference value between a target speed according to the determined target acceleration and the current speed of the vehicle, and control the motor to transmit the updated creep torque to wheels of the vehicle.

The controller may update the reverse component of the determined creep torque to be higher in proportion to the difference value when the target speed is lower than the current speed of the vehicle and update the forward component of the determined creep torque to be higher in proportion to the difference value when the target speed is higher than the current speed of the vehicle.

The controller may be configured to determine an update value by performing a proportional-integral (PI) control operation on the difference value between the target speed and the current speed of the vehicle and update the determined creep torque by summing the determined creep torque and the determined update data.

The controller may be configured to determine a P gain and an I gain in the PI control operation based on correlation information between a driving mode of the vehicle and the PI control and the driving mode of the vehicle.

The controller may adjust the update value in a direction cancelling the disturbance due to a disturbance observer (DOB) control operation.

The controller may update the determined creep torque when the difference value between the target speed and the current speed of the vehicle is equal to or greater than a predetermined threshold value.

The controller may be configured to determine the creep torque based on correlation information between a driving mode of the vehicle and the creep torque and the driving mode of the vehicle.

The controller may be configured to determine the target acceleration based on correlation information between a driving mode of the vehicle and the target acceleration and the driving mode of the vehicle.

The vehicle may further include a communicator configured to perform communication with an external server. The controller may be configured to control the communicator to receive at least one of road traffic information related to a road on which the vehicle is driving from the external server and weather information related to an area where the vehicle is located.

The controller may adjust the determined target acceleration based on at least one of the road traffic information and the weather information.

The vehicle may further include a tilt sensor configured to detect a tilt of the vehicle. The controller may be configured to determine a gradient of a road on which the vehicle is driving based on an output value of the tilt sensor

The controller may adjust at least one of the determined creep torque and the determined target acceleration so that the forward component is increased in proportion to the gradient when the gradient indicates an uphill slope.

The controller may adjust at least one of the determined creep torque and the determined target acceleration so that the reverse component is increased in proportion to the gradient when the gradient indicates a downhill slope.

In accordance with another aspect of the present invention, a method for controlling a vehicle which may include a motor, a transmission, and a vehicle speed sensor configured to detect a speed of the vehicle may include: determining a target acceleration and a creep torque based on a current speed of the vehicle and a gear ratio of the transmission when the vehicle satisfies a creep driving condition; updating the determined creep torque based on a difference value between a target speed according to the determined target acceleration and the current speed of the vehicle; and controlling the motor to transmit the updated creep torque to wheels of the vehicle.

The updating of the determined creep torque may include updating the reverse component of the determined creep torque to be higher in proportion to the difference value when the target speed is lower than the current speed of the vehicle; and updating the forward component of the determined creep torque to be higher in proportion to the difference value when the target speed is higher than the current speed of the vehicle.

The updating of the determined creep torque may include determining an update value by performing a proportional-integral (PI) control operation on the difference value between the target speed and the current speed of the vehicle; and updating the determined creep torque by summing the determined creep torque and the determined update data.

The updating of the determined creep torque may include determining a P gain and an I gain in the PI control operation based on correlation information between a driving mode of the vehicle and the PI control and the driving mode of the vehicle.

The updating of the determined creep torque may include adjusting the update value in a direction cancelling the disturbance due to a disturbance observer (DOB) control operation.

The updating of the determined creep torque may include updating the determined creep torque when the difference value between the target speed and the current speed of the vehicle is equal to or greater than a predetermined threshold value.

The determining of the creep torque may include determining the creep torque based on correlation information between a driving mode of the vehicle and the creep torque and the driving mode of the vehicle.

The determining of the target acceleration may include determining the target acceleration based on correlation information between a driving mode of the vehicle and the target acceleration and the driving mode of the vehicle.

The vehicle may further include a communicator configured to perform communication with an external server. The method may further include controlling the communicator to receive at least one of road traffic information related to a road on which the vehicle is driving from the external server and weather information related to an area where the vehicle is located.

The method may further include adjusting the determined target acceleration based on at least one of the road traffic information and the weather information.

The vehicle may further include a tilt sensor configured to detect a tilt of the vehicle. The method may further include determining a gradient of a road on which the vehicle is driving based on an output value of the tilt sensor.

The method may further include adjusting the determined creep torque so that the forward component is increased in proportion to the gradient when the gradient indicates an uphill slope; and adjusting the determined creep torque so that the reverse component is increased in proportion to the gradient when the gradient indicates a downhill slope.

The method may further include adjusting the determined target acceleration so that the forward component is increased in proportion to the gradient when the gradient indicates an uphill slope; and adjusting the determined target acceleration so that the reverse component is increased in proportion to the gradient when the gradient indicates a downhill slope.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view exemplarily illustrating a power system and a control system of a vehicle according to an exemplary embodiment of the present invention;

FIG. 2 is a control block diagram of the vehicle according to an exemplary embodiment of the present invention;

FIG. 3 is a view exemplarily illustrating a load applied to the vehicle during creep driving of the vehicle according to an exemplary embodiment of the present invention;

FIG. 4 is a graph illustrating a speed change according to a driving load of the vehicle according to an exemplary embodiment of the present invention;

FIG. 5 is a graph illustrating a creep torque control according to a speed of the vehicle according to an exemplary embodiment of the present invention;

FIG. 6 is a view exemplarily illustrating a table for setting a target acceleration of the vehicle according to an exemplary embodiment of the present invention;

FIG. 7 is a view exemplarily illustrating a table of correction coefficients according to a gradient and a speed for setting the target acceleration of the vehicle according to an exemplary embodiment of the present invention;

FIG. 8 is a graph illustrating a creep torque according to the speed of the vehicle according to an exemplary embodiment of the present invention;

FIG. 9 is a view exemplarily illustrating a case in which the creep torque of the vehicle is updated according to an exemplary embodiment of the present invention; and

FIG. 10 is a flowchart illustrating a case in which the creep torque is updated during the creep driving in a vehicle control method according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Like reference numerals refer to like elements throughout the specification. Not all elements of embodiments of the present invention will be described, and description of what are commonly known in the art or what overlap each other in the exemplary embodiments will be omitted.

Throughout the present specification, when a part is referred to as being “connected” to another portion, it includes not only a direct connection but also an indirect connection, and the indirect connection includes a connection through a wireless communication network.

Furthermore, when a part is referred to as “including” a component, this indicates that the part may include another element, not excluding another element unless specifically stated otherwise.

The singular forms include plural forms unless the context clearly notes otherwise.

Furthermore, the terms “˜part,” “˜er,” “˜block,” “˜module,” and the like may refer to a unit for processing at least one function or operation. For example, these terms may refer to at least one process which is performed by at least one piece of hardware such as a field-programmable gate array (FPGA) and an application specific integrated circuit (ASIC), at least one piece of software stored in a memory, or a processor.

A reference numeral, which is assigned to each step, is used for discriminating each step and does not describe the order of the steps, and these steps may be differently performed from the described order unless clearly specified in the context.

Hereinafter, embodiments of a vehicle and a method for controlling the same according to an aspect will be described in detail with reference to the accompanying drawings.

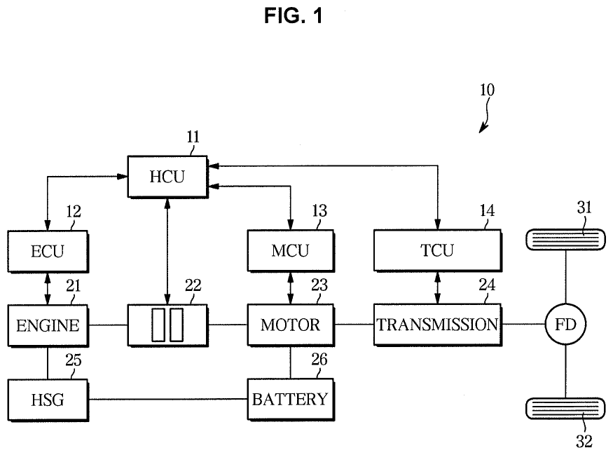

FIG. 1 is a view exemplarily illustrating a power system and a control system of a vehicle according to an exemplary embodiment of the present invention.

Referring to FIG. 1, a power system and a control system of a vehicle 10 may include a hybrid control unit (HCU) 11, an engine control unit (ECU) 12, a motor control unit (MCU) 13, a transmission control unit (TCU) 14, an engine 21, an engine clutch 22, a motor 23, a transmission 24, a hybrid starter and generator (HSG) 25, and a battery 26.

At the instant time, the vehicle 10 may correspond to a hybrid electric vehicle (HEV).

Furthermore, the vehicle 10 may correspond to an electric vehicle (EV) and a fuel cell vehicle. In the instant case, the vehicle 10 excluding the engine 21 may be omitted from configurations 11, 12, 22, and 25 related to the engine 21 unlike that illustrated in FIG. 1.

Thus, the vehicle 10 may correspond to an eco-friendly vehicle which may be driven by the power of the motor 23, and as described below, creep driving may be accelerated to a constant speed at a low speed and gradually decelerated at a high speed. To support this, the motor 23 is controlled so that a torque, called creep torque, is output to each of wheels 31 and 32 when an accelerator pedal and a brake pedal are not pressed.

The HCU 11 may be a top-level controller for controlling the overall operation of the vehicle 10. Furthermore, the HCU 11 may integrally manage the control of the other controllers 12, 13, and 14. To the present end, the HCU 11 may connect the controllers 12, 13 and 14 to each other through a Controller Area Network (CAN) communication line to exchange information with each other and perform cooperative control to control an output torque of the engine 21 and the motor 23.

However, the HCU 11 may be interconnected with the other controllers 12, 13, and 14 based on communication techniques (e.g., Ethernet, Media Oriented Systems Transport (MOST), Flexray, Local Interconnect Network (LIN), etc.) other than CAN communication.

The ECU 12 may control the overall operation of the engine 21, the MCU 13 may control the overall operation of the motor 23, and the TCU 14 may control the overall operation of the transmission 24.

The engine 21 may output power in a starting-on state as the power source. However, the engine 21 may be omitted depending on the type of the vehicle 10, as described above.

The engine clutch 22 may be disposed between the engine 21 and the motor 23 and selectively connect the engine 21 and the motor 23 in accordance with the driving of the vehicle 10 by receiving a control signal of the HCU 11.

The motor 23 is operated by a three-phase alternating voltage applied through an inverter in the battery 26 to generate the torque and may transmit the creep torque to each of the wheels 31 and 32 during the creep driving to provide a deceleration feeling or acceleration feeling during the creep driving.

The transmission 24 may be supplied with an input torque as the sum of the output torque of the engine 21 and the output torque of the motor 23 determined according to the engagement and disengagement of the engine clutch 22, and may maintain the driving of the vehicle 10 by outputting the input torque to each of the wheels 31 and 32 by selecting an arbitrary gear ratio according to a vehicle speed and a driving condition or according to a user's selection.

The HSG 25 may be controlled to start the engine 21 or may be generated by the output of the engine 21. At the instant time, the HSG 25 may supply power to the battery 26 through power generation.

The battery 26 may include a plurality of unit cells, and may store energy for driving the motor 23 (for example, a voltage of 400 V to 450 V of direct current).

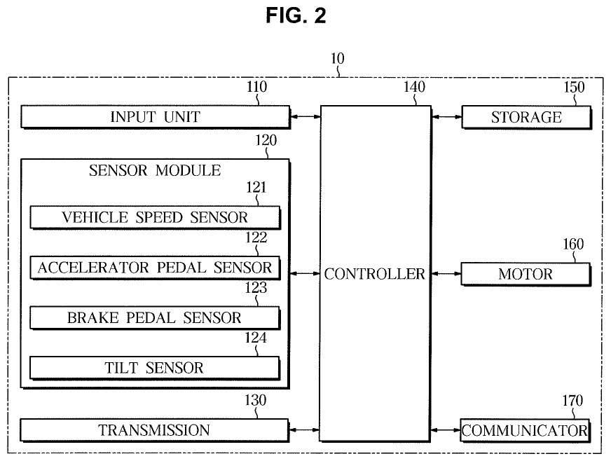

FIG. 2 is a control block diagram of the vehicle according to an exemplary embodiment of the present invention.

Referring to FIG. 2, the vehicle 10 may include an input unit 110 for receiving an input from a user of the vehicle 10, a sensor module 120 for detecting various information related to the vehicle 10 such as a speed of the vehicle 10, a position of the accelerator pedal, a position of the brake pedal, and a tilt of the vehicle 10, a transmission 130 for outputting the torque input from the engine 21 or the motor 23 to each of the wheels 31 and 32 on the basis of a set gear ratio, a controller 140 for setting a target acceleration to provide a constant deceleration or acceleration to the vehicle 10 in a case of creep driving and updating the creep torque based on the target acceleration, a storage 150 for storing various information for updating the creep torque, a motor 160 for outputting a driving force and the creep torque for driving the vehicle 10, and a communicator 170 for performing communication with an external server.

The input unit 110 may receive the user's input. The input unit 110 may be provided in a center fascia disposed at the center portion of a dashboard and may be implemented with mechanical buttons, knobs, a touch pad, a touch screen, a stick-type manipulation device, a trackball, or the like. At the instant time, the input unit 110 disposed on the touch screen may be provided on a display provided within the vehicle 10. However, the position and implementation method of the input unit 110 are not limited to the above-described example, and may be included without limitation as long as the position and the implementation method in which the user's input may be received.

The input unit 110 may receive the input for a driving mode of the vehicle 10 from the user and may receive the input for the gear ratio of the transmission 130.

At the instant time, the driving mode of the vehicle 10 may include a normal mode, a sports mode in which the responsiveness of the user to the accelerator pedal, the brake pedal, and a steering wheel is higher than that of the normal mode and the acceleration feeling or deceleration feeling during creep driving is greater than that of the normal mode, and an echo mode in which the responsiveness of the user to the accelerator pedal, the brake pedal, and the steering wheel is lower than that of the normal mode and the acceleration feeling or deceleration feeling during creep driving is smaller than that of the normal mode.

Also, the higher the gear ratio of the transmission 130 input through the input unit 110, the higher the speed of the vehicle 10 may be, which may mean that the user intends to accelerate.

The sensor module 120 may include at least one of a vehicle speed sensor 121 for detecting the driving speed of the vehicle 10, an accelerator pedal sensor 122 for detecting the position of the accelerator pedal, and a brake pedal sensor 123 for detecting the position of the brake pedal and a tilt sensor 124 for detecting a tilt of the vehicle 10 to detect the condition of the vehicle 10.

The transmission 130 may correspond to the transmission 24 in FIG. 1 and may output the torque input from the engine 21 or the motor 23 to the wheels 31 and 32 based on the set gear ratio.

Also, the transmission 130 may provide the controller 140 with information on the set gear ratio.

In engine-driven vehicles, an idle torque of an engine is transmitted to a torque converter and the transmission even when the accelerator pedal and the brake pedal are not pressed while driving. Therefore, creep driving is accelerated to a constant speed at a low speed and gradually decelerated at a high speed.

Creep driving is a natural phenomenon without special control when the engine of the engine-driven vehicles is in operation. In contrast, natural creep driving may not be possible in eco-friendly vehicles which may be driven by the power of a motor.

Therefore, in the vehicle 10, which corresponds to the EV, the HEV, and the fuel cell vehicle which may be driven by the motor 160, the motor 160 is controlled so that a torque, which is called creep torque, is outputted to the wheels 31 and 32 when the accelerator pedal and the brake pedal are not pressed to generate a feeling of driving similar to the creep driving of existing engine-driven vehicles.

However, a general creep torque determination method may change the acceleration feeling or deceleration feeling during the creep driving depending on the driving load by use of a predetermined creep torque according to the vehicle speed irrespective of the driving load, which may vary depending on the weight change of the vehicle 10, the air pressure of a tire, a road gradient, the air density in a driving environment and the like.

To solve the present problem, the vehicle 10 may determine the target acceleration and the creep torque according to the speed and the gear ratio, and update the determined creep torque based on the difference value between a target speed and a current speed according to the target acceleration so that the vehicle 10 drives at the target speed under any driving load so that the acceleration feeling or deceleration feeling during the creep driving may be constantly provided.

The controller 140 may determine the target acceleration and the creep torque based on the current speed of the vehicle 10 and the gear ratio of the transmission 130 when the vehicle 10 satisfies the creep driving condition, update the determined creep torque based on the difference value between the target speed according to the acceleration and the current speed of the vehicle 10, and control the motor 160 to transmit the updated creep torque to the wheels 31 and 32 of the vehicle 10.

The controller 140 may determine that the vehicle 10 satisfies the creep driving condition when output values of the accelerator pedal sensor 122 and the brake pedal sensor 123 correspond to “0,” that is, when the user of the vehicle 10 does not press the accelerator pedal and the brake pedal.

The controller 140 may update the determined creep torque so that the reverse component of the determined creep torque is increased in proportion to the difference value between the target speed and the current speed when the target speed is lower than the current speed of the vehicle 10.

The controller 140 may also update the determined creep torque so that the forward component of the determined creep torque is increased in proportion to the difference value between the target speed and the current speed when the target speed is higher than the current speed of the vehicle 10.

At the instant time, the forward component of the creep torque may refer to a component of the creep torque transmitted to the wheel so that the vehicle 10 accelerates when the vehicle 10 is driving forward thereof. The reverse component of the creep torque may refer to a component of the creep torque transmitted to the wheel so that the vehicle 10 decelerates when the vehicle 10 is driving forward thereof.

The creep torque transmitted to the wheel of the vehicle 10 may be updated in the direction in which the creep torque in the reverse direction (negative) becomes higher when the target speed is lower than the current speed of the vehicle 10 so that the acceleration of the vehicle 10 is decreased and the speed of the vehicle 10 can reach the target speed.

The creep torque transmitted to the wheel of the vehicle 10 may be updated in the direction in which the creep torque in the forward direction (positive) becomes higher when the target speed is higher than the current speed of the vehicle 10 so that the acceleration of the vehicle 10 is increased and the speed of the vehicle 10 can reach the target speed.

To the present end, the controller 140 may perform a proportional-integral (PI) control operation on the difference value between the target speed and the current speed of the vehicle 10 to determine an updated value, and may update the determined creep torque by summing the determined creep torque and the determined update value.

The controller 140 may determine a P gain and an I gain in the PI control operation based on the correlation information between the driving mode of the vehicle 10 stored in the storage 150 and the PI control and the driving mode of the vehicle 10 set through the input unit 110.

That is, the controller 140 may set the P gain and the I gain in the PI control operation differently according to the driving mode of the vehicle 10. The controller 140 may increase the P gain and the I gain each time the mode is switched to the economical mode, the normal mode, and the sports mode. That is, in the sports mode, the speed of the vehicle 10 may reach the target speed faster than in the normal mode, and in the economical mode, the speed of the vehicle 10 may reach the target speed more slowly than in the normal mode. Accordingly, the user may feel a faster speed change in the sports mode and energy efficiency according to a slow speed change in the economical mode.

The controller 140 may perform a disturbance observer (DOB) control operation in addition to the PI control operation to adjust the update value determined according to the PI control operation in a direction canceling the disturbance due to the DOB control operation.

The controller 140 may also adjust the sensitivity of the creep torque update by updating the determined creep torque when the difference value between the target speed and the current speed of the vehicle 10 is equal to or greater than a predetermined threshold value. At the instant time, the threshold value may be adjusted by the user through the input unit 110, and may be set in the design stage and stored in the storage 150.

The controller 140 may determine the creep torque before being updated based on the correlation information between the driving mode and the creep torque of the vehicle 10 stored in the storage 150 and the driving mode of the vehicle 10 set through the input unit 110.

That is, the storage 150 may store a table in which the creep torque for the same vehicle speed and the gear ratio is set differently according to the driving mode of the vehicle 10.

Each time the mode is switched to the economical mode, the normal mode, and the sports mode, the controller 140 may increase the creep torque for the same vehicle speed and the gear ratio based on the correlation information between the driving mode and the creep torque stored in the storage 150.

That is, the creep torque may be set to be higher than the normal mode in the sports mode, and the creep torque may be set to be lower than the normal mode in the economical mode.

Accordingly, in the sports mode, the user may feel the acceleration feeling or deceleration feeling more rapidly when the creep driving is started by pressing the accelerator pedal or the brake pedal and removing the pressure. In the economical mode, the energy efficiency may be increased by decelerating or accelerating more slowly when the creep driving is started by pressing the accelerator pedal or the brake pedal and removing the pressure.

Furthermore, the controller 140 may determine the road gradient on which the vehicle 10 is driving based on an output value of the tilt sensor 124, and adjust the creep torque before being updated based on the determined gradient. That is, the controller 140 may adjust the creep torque determined according to the speed of the vehicle 10 and the gear ratio based on the road gradient before being updated based on the difference value between the target speed and the current speed.

The controller 140 may adjust the determined creep torque so that the forward component is increased in proportion to the road gradient when the road gradient indicates an uphill slope, and may adjust the determined creep torque so that the reverse component is increased in proportion to the road gradient when the road gradient indicates a downhill slope.

That is, the controller 140 may adjust the determined creep torque so that the forward component is increased to reach the target speed according to the target acceleration when the vehicle 10 drives uphill, and may adjust the determined creep torque so that the reverse component is increased to prevent the vehicle 10 from exceeding the target speed according to the target acceleration when the vehicle 10 drives downhill.

The controller 140 may determine the target acceleration for determining the target speed to be compared with the current speed. The controller 140 may determine the target acceleration based on the current speed of the vehicle 10 and the gear ratio of the transmission 130.

To the present end, the target acceleration according to the speed of the vehicle 10 and the gear ratio may be preset and stored in the storage 150. That is, information on the target acceleration according to the speed of the vehicle 10 and the gear ratio may be stored in the storage 150 in a form of a table.

Below a predetermined threshold speed, the target acceleration in the forward direction (positive) may be preset so that the vehicle 10 accelerates when driving forward thereof. Above the predetermined threshold speed, the target acceleration in the reverse direction (negative) may be preset so that the vehicle 10 decelerates when driving forward thereof. At the instant time, the target acceleration may be decelerated in proportion to the speed of the vehicle 10 or exponentially up to a predetermined upper limit speed, and converged to the target acceleration corresponding to the predetermined upper limit speed at a speed higher than the predetermined upper limit speed.

That is, as the current speed of the vehicle 10 is increased, the absolute value of the target acceleration in the reverse direction (negative) may become larger. Accordingly, when the vehicle 10 enters the creep driving state in a state where the current speed of the vehicle 10 is fast, the user of the vehicle 10 may feel a greater deceleration feeling.

Information on the target acceleration according to the speed of the vehicle 10 and the gear ratio may be set such that the absolute value of the target acceleration in the reverse direction (negative) for deceleration becomes lower as the gear ratio increases. Accordingly, in a situation where the gear ratio corresponds to a high gear ratio that desires a fast acceleration feeling, the deceleration feeling may be made lower than in the case of a lower gear ratio.

The controller 140 may also determine the target acceleration based on the correlation information between the driving mode of the vehicle 10 and the target acceleration and the driving mode of the vehicle 10.

The storage 150 may store correlation information between the driving mode of the vehicle 10 and the target acceleration. The storage 150 may store information on the target acceleration according to the speed and the gear ratio for each driving mode of the vehicle 10. The controller 140 may determine information on the target acceleration according to the corresponding speed and the gear ratio based on the driving mode of the vehicle 10 and determine the target acceleration corresponding to the current speed and the current gear ratio based on the determined information related to the target acceleration.

At the instant time, the absolute value of the target acceleration may be set larger in the sports mode than in the normal mode, and the absolute value of the target acceleration may be set smaller in the economical mode than in the normal mode. Thus, in the sports mode, a greater acceleration feeling or deceleration feeling may be felt when the creep driving is entered according to the operation of the accelerator pedal and the brake pedal, and the user may feel a more dynamic driving feeling. Also, in the economical mode, the energy efficiency may be improved by setting the width of speed change to be lower when entering creep driving than in the normal mode.

The controller 140 may also control the communicator 170 to receive at least one of road traffic information related to a road on which the vehicle 10 is driving from the external server and weather information related to an area where the vehicle 10 is located.

To the present end, the communicator 170 may communicate with the external server using various methods. The various methods such as Radio Frequency (RF), Wireless Fidelity (Wi-Fi), Bluetooth, Zigbee, Near Field Communication (NFC), and Ultra-Wide Band (UWB) may be used to transmit and receive information to or from the external server. As a method of performing communication with the external server, the method is not limited to the above-described method, and any method may be used as long as it can communicate with the external server.

Also, in FIG. 2, the communicator 170 is illustrated as a single component transmitting and receiving a signal, without being limited thereto, and a transmitter for transmitting the signal and a receiver for receiving the signal may be separately provided.

The controller 140 may adjust the target acceleration determined by the current speed and the current gear ratio based on at least one of the road traffic information and the weather information obtained from the external server through the communicator 170.

For example, the target acceleration determined according to the type of road designated by the road traffic information may be adjusted. The type of road may include highways, national roads, and city roads. The controller 140 may adjust the absolute value of the target acceleration higher than the absolute value of the target acceleration on national roads when the type of the road corresponds to highways. The controller 140 may adjust the absolute value of the target acceleration lower than the absolute value of the target acceleration on national roads when the type of the road corresponds to city roads.

Furthermore, the controller 140 may adjust the target acceleration determined based on the current speed and the current gear ratio according to the degree of road congestion included in the road traffic information. That is, the controller 140 may adjust the absolute value of the target acceleration determined as the road congestion becomes higher.

Furthermore, the controller 140 may adjust the determined target acceleration to a low level when the weather in the area where the vehicle 10 designated by the weather information corresponds to snow or rain. Accordingly, the vehicle 10 may ensure safe driving even when the vehicle 10 enters the creep driving under snowy or rainy conditions.

Furthermore, the controller 140 may adjust the target acceleration determined according to the current speed and the current gear ratio according to the road gradient on which the vehicle 10 is driving.

The controller 140 may adjust the determined target acceleration so that the forward component is increased in proportion to the road gradient when the road gradient indicates an uphill slope, and may adjust the determined target acceleration so that the reverse component is increased in proportion to the road gradient when the road gradient indicates a downhill slope.

That is, the controller 140 may prevent the vehicle 10 from being slowed differently than intended by adjusting the target acceleration determined so that the target acceleration is increased in the positive direction when the vehicle 10 drives uphill. The controller 140 may prevent the vehicle 10 from being accelerated differently than intended by adjusting the target acceleration determined so that the target acceleration is increased in the negative direction when the vehicle 10 drives downhill.

The controller 140 may include at least one memory that stores a program for performing the above-described operations and the operations described below, and at least one processor that executes the stored program. When there is a plurality of memories and processors, they may be integrated on one chip, or they may be provided in physically separated positions.

The storage 150 may correspond to a memory that stores the above-described information and the following information, and may be implemented with at least one of a non-volatile memory device, such as cache, read only memory (ROM), programmable ROM (PROM), erasable programmable ROM (EPROM), or electrically erasable programmable ROM (EEPROM); a volatile memory device, such as random access memory (RAM); or a storage medium, such as a hard disk drive (HDD) or compact disk ROM (CD-ROM) to store various information, without being limited thereto.

The motor 160 may correspond to the motor 23 of FIG. 1 and may provide a driving force to the wheels 31 and 32 in a driving state and may provide the determined creep torque or the updated creep torque to the wheels 31 and 32 based on the control of the controller 140 during the creep driving.

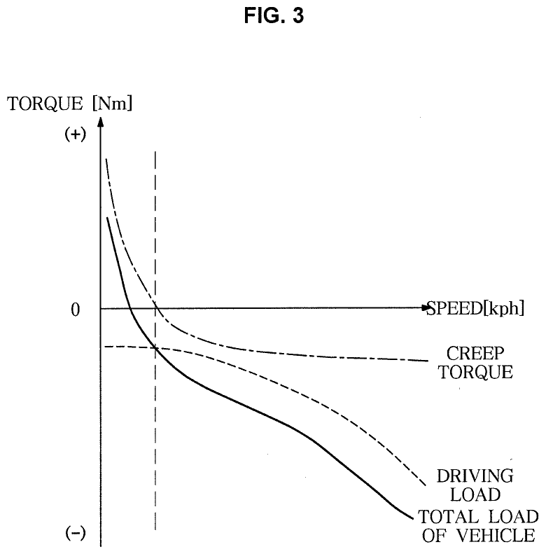

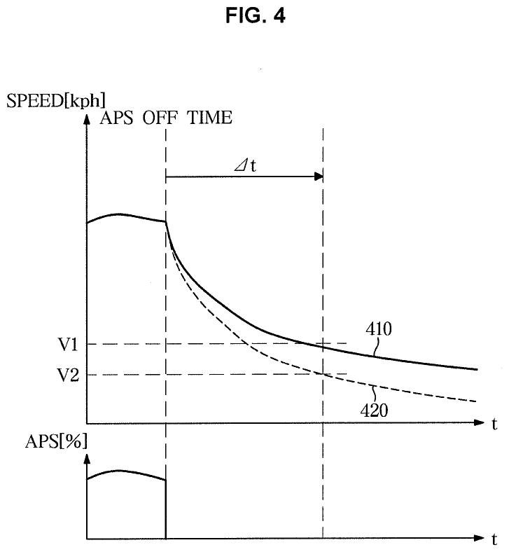

FIG. 3 is a view exemplarily illustrating a load applied to the vehicle during creep driving of the vehicle according to an exemplary embodiment of the present invention, and FIG. 4 is a graph illustrating a speed change according to a driving load of the vehicle according to an exemplary embodiment of the present invention.

Referring to FIG. 3, in general, the eco-friendly vehicle driven by the motor accelerates or decelerates, i.e., the creep driving, based on the creep torque provided to each wheel by the motor, even when the accelerator pedal and the brake pedal are not pressed.

in the vehicle 10, which corresponds to the EV, the HEV, and the fuel cell vehicle which may be driven by the motor 160, the motor 160 is controlled so that a torque, which is called a creep torque, is outputted to the wheels 31 and 32 when the accelerator pedal and the brake pedal are not pressed to generate a feeling of driving similar to the creep driving of existing engine-driven vehicles.

However, the general creep torque determination method may change the acceleration feeling or deceleration feeling during the creep driving depending on the driving load by use of the predetermined creep torque according to the vehicle speed irrespective of the driving load, which may vary depending on the weight change of the vehicle 10, the air pressure of the tire, the road gradient, the air density in a driving environment and the like.

In other words, as illustrated in FIG. 3, in the general creep torque determination method, by use of the predetermined creep torque according to the vehicle speed, the total load of the vehicle applied to the vehicle may be changed as the driving load is changed and the acceleration feeling or deceleration feeling during the creep driving may be changed based on this.

Referring to FIG. 4, at the time point when the output value of the accelerator pedal sensor 122 becomes “0” (when the accelerator pedal sensor (APS) is off) as the user does not press the accelerator pedal, the eco-friendly vehicle may perform the creep driving according to the predetermined creep torque.

At the instant time, as illustrated in FIG. 4, in a situation where the driving load is increased, such as when the weight of the vehicle is increased due to a large payload, the vehicle may exhibit a lower speed (420) compared to the speed (410) under normal driving conditions. That is, a vehicle having a high driving load may exhibit a lower speed V2 than a vehicle speed V1 of the normal driving load after the same time (Δt) from the time of depressing the accelerator pedal.

To solve the present problem, the vehicle 10 may determine the target acceleration and the creep torque according to the speed and the gear ratio, update the creep torque determined based on the difference value between the target speed and the current speed according to the target acceleration so that the vehicle 10 drives at the target speed under any driving load so that the acceleration feeling or deceleration feeling during the creep driving may be constantly provided. Hereinafter, the updating of the creep torque by the vehicle 10 will be described in detail.

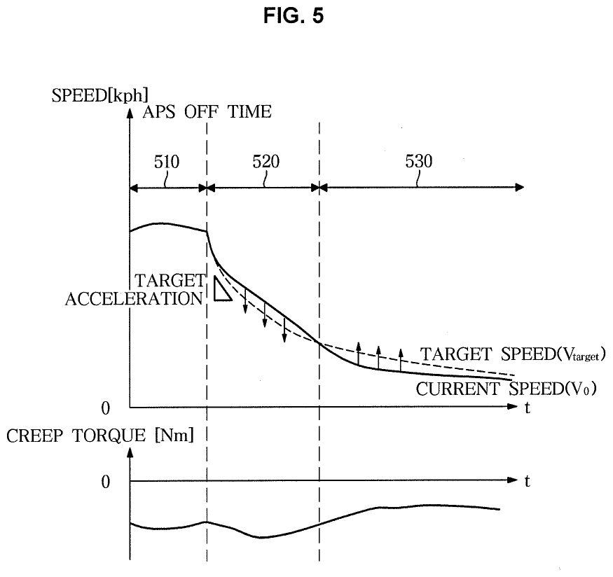

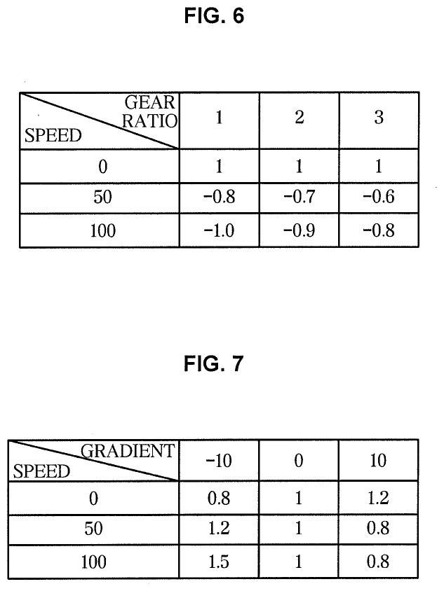

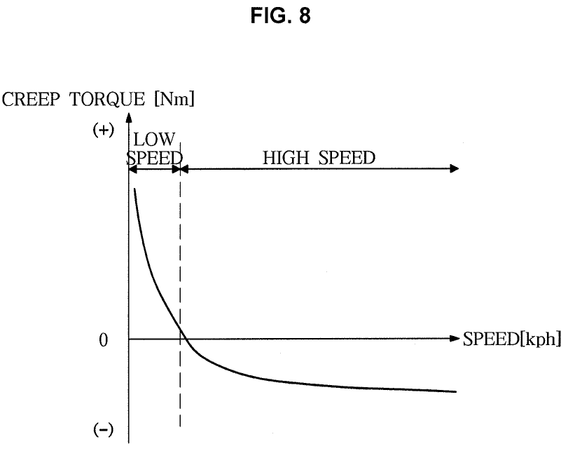

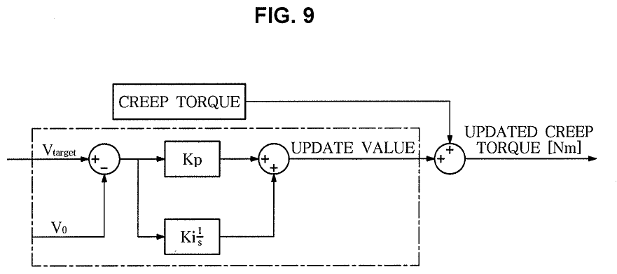

FIG. 5 is a graph illustrating a creep torque control according to a speed of the vehicle according to an exemplary embodiment of the present invention, FIG. 6 is a view exemplarily illustrating a table for setting a target acceleration of the vehicle according to an exemplary embodiment of the present invention, FIG. 7 is a view exemplarily illustrating a table of correction coefficients according to a gradient and a speed for setting the target acceleration of the vehicle according to an exemplary embodiment of the present invention, FIG. 8 is a graph illustrating a creep torque according to the speed of the vehicle according to an exemplary embodiment of the present invention, and FIG. 9 is a view exemplarily illustrating a case in which the creep torque of the vehicle is updated according to an exemplary embodiment of the present invention.

Referring to FIG. 5, the controller 140 may determine the target acceleration and the creep torque based on the current speed of the vehicle 10 and the gear ratio of the transmission 130, update the determined creep torque based on the difference value between the target speed according to the determined target acceleration and the current speed of the vehicle 10, and control the motor 160 to transmit the updated creep torque to the wheels 31 and 32 of the vehicle 10 when the vehicle 10 satisfies the creep driving condition, i.e., when the user of the vehicle 10 does not press the accelerator pedal and the brake pedal (e.g., after the APS OFF time (after section 510)).

That is, the controller 140 may determine the target acceleration at the start point of a predetermined time section, determine the target speed at the end point of the predetermined time section based on the target acceleration and the speed at the start point, and update the determined creep torque based on the difference.

When the target speed is lower than the current speed of the vehicle 10 (section 520), the controller 140 may update the determined creep torque so that the reverse component of the creep torque determined in proportion to the difference value between the target speed and the current speed is increased.

For example, as illustrated in FIG. 5, during the creep driving where the user of the vehicle 10 decelerates by depressing the accelerator pedal, when the target speed is lower than the current speed, the creep torque increases in the reverse direction (negative), so that the vehicle 10 decelerates more rapidly and the speed of the vehicle 10 may be lowered to the target speed.

The controller 140 may update the determined creep torque so that the forward component of the determined creep torque is increased in proportion to the difference value between the target speed and the current speed when the target speed is higher than the current speed of the vehicle 10.

For example, as illustrated in FIG. 5, during the creep driving where the user of the vehicle 10 decelerates by depressing the accelerator pedal, when the target speed is higher than the current speed, the creep torque increases in the forward direction (positive), so that the vehicle 10 decelerates more slowly and the speed of the vehicle 10 may reach the target speed.

At the instant time, the forward component of the creep torque may refer to a component of the creep torque transmitted to the wheel so that the vehicle 10 accelerates when the vehicle 10 is driving forward thereof. The reverse component of the creep torque may refer to a component of the creep torque transmitted to the wheel so that the vehicle 10 decelerates when the vehicle 10 is driving forward thereof.

The creep torque transmitted to the wheel of the vehicle 10 may be updated in the direction in which the creep torque in the reverse direction (negative) becomes higher when the target speed is lower than the current speed of the vehicle 10 so that the acceleration of the vehicle 10 is decreased and the speed of the vehicle 10 can reach the target speed.

The creep torque transmitted to the wheel of the vehicle 10 may be updated in the direction in which the creep torque in the forward direction (positive) becomes higher when the target speed is higher than the current speed of the vehicle 10 so that the acceleration of the vehicle 10 is increased and the speed of the vehicle 10 can reach the target speed.

To the present end, the controller 140 may preferentially set the target acceleration based on the speed of the vehicle 10 and the gear ratio.

That is, the controller 140 may determine the target acceleration for determining the target speed to be compared with the current speed. The controller 140 may determine the target acceleration based on the current speed of the vehicle 10 and the gear ratio of the transmission 130.

Referring to FIG. 6, the target acceleration according to the speed of the vehicle 10 and the gear ratio may be preset and stored in the storage 150. That is, information on the target acceleration according to the speed of the vehicle 10 and the gear ratio may be stored in the storage 150 in a form of a table.

At the instant time, below the predetermined threshold speed, the target acceleration in the forward direction (positive) may be preset so that the vehicle 10 accelerates when driving forward thereof. Above the predetermined threshold speed, the target acceleration in the reverse direction (negative) may be preset so that the vehicle 10 decelerates when driving forward thereof. At the instant time, the target acceleration may be decelerated in proportion to the speed of the vehicle 10 or exponentially up to a predetermined upper limit speed, and converged to the target acceleration corresponding to the predetermined upper limit speed at a speed higher than the predetermined upper limit speed.

That is, as the current speed of the vehicle 10 is increased, the absolute value of the target acceleration in the reverse direction (negative) may become larger. Accordingly, when the vehicle 10 enters the creep driving state in a state where the current speed of the vehicle 10 is fast, the user of the vehicle 10 may feel a greater deceleration feeling.

The information on the target acceleration according to the speed of the vehicle 10 and the gear ratio may be set such that the absolute value of the target acceleration in the reverse direction (negative) for deceleration becomes lower as the gear ratio increases. Accordingly, in a situation where the gear ratio corresponds to the high gear ratio that desires a fast acceleration feeling, the deceleration feeling may be made lower than in the case of a lower gear ratio.

in a situation where the gear ratio corresponds to the high gear ratio that desires a fast acceleration feeling

The controller 140 may also determine the target acceleration based on the correlation information between the driving mode of the vehicle 10 and the target acceleration and the driving mode of the vehicle 10.

The storage 150 may store correlation information between the driving mode of the vehicle 10 and the target acceleration. The storage 150 may store information on the target acceleration according to the speed and the gear ratio for each driving mode of the vehicle 10. The controller 140 may determine information on the target acceleration according to the corresponding speed and the gear ratio based on the driving mode of the vehicle 10 and determine the target acceleration corresponding to the current speed and the current gear ratio based on the determined information related to the target acceleration.

At the instant time, the absolute value of the target acceleration may be set larger in the sports mode than in the normal mode, and the absolute value of the target acceleration may be set smaller in the economical mode than in the normal mode. Thus, in the sports mode, a greater acceleration feeling or deceleration feeling may be felt when the creep driving is entered according to the operation of the accelerator pedal and the brake pedal, and the user may feel a more dynamic driving feeling. Also, in the economical mode, the energy efficiency may be improved by setting the width of speed change to be lower when entering creep driving than in the normal mode.

The controller 140 may also control the communicator 170 to receive at least one of the road traffic information related to the road on which the vehicle 10 is driving from the external server and the weather information related to the area where the vehicle 10 is located.

The controller 140 may adjust the target acceleration determined by the current speed and the current gear ratio based on at least one of the road traffic information and the weather information obtained from the external server through the communicator 170.

For example, the target acceleration determined according to the type of road designated by the road traffic information may be adjusted. The type of road may include highways, national roads, and city roads. The controller 140 may adjust the absolute value of the target acceleration higher than the absolute value of the target acceleration on national roads when the type of the road corresponds to highways. The controller 140 may adjust the absolute value of the target acceleration lower than the absolute value of the target acceleration on national roads when the type of the road corresponds to city roads.

Furthermore, the controller 140 may adjust the target acceleration determined based on the current speed and the current gear ratio according to the degree of road congestion included in the road traffic information. That is, the controller 140 may adjust the absolute value of the target acceleration determined as the road congestion becomes higher.

Furthermore, the controller 140 may adjust the determined target acceleration to a low level when the weather in the area where the vehicle 10 designated by the weather information corresponds to snow or rain. Accordingly, the vehicle 10 may ensure safe driving even when the vehicle 10 enters the creep driving under snowy or rainy conditions.

Furthermore, the controller 140 may adjust the target acceleration determined according to the current speed and the current gear ratio according to the road gradient on which the vehicle 10 is driving.

The controller 140 may adjust the determined target acceleration so that the forward component is increased in proportion to the road gradient when the road gradient indicates an uphill slope, and may adjust the determined target acceleration so that the reverse component is increased in proportion to the road gradient when the road gradient indicates a downhill slope.

That is, the controller 140 may prevent the vehicle 10 from being slowed differently than intended by adjusting the target acceleration determined so that the target acceleration is increased in the positive direction when the vehicle 10 drives uphill. The controller 140 may prevent the vehicle 10 from being accelerated differently than intended by adjusting the target acceleration determined so that the target acceleration is increased in the negative direction when the vehicle 10 drives downhill.

To the present end, referring to FIG. 7, the storage 150 may store the table of correction coefficients according to the gradient and the speed. In the instant case, the controller 140 may adjust the determined target acceleration based on the table of the correction coefficients stored in the storage 150. That is, the controller 140 may adjust the determined target acceleration by multiplying the determined target acceleration by the correction coefficient corresponding to the gradient and the speed.

As illustrated in FIG. 7, the correction factor according to the gradient and the speed may be increased in proportion to the road gradient at the predetermined threshold speed or less, and may be decreased in proportion to the road gradient at the predetermined threshold speed or above so that the forward component of the target acceleration determined in proportion to the road gradient may be increased when the road gradient indicates an uphill slope.

That is, when the vehicle 10 is in the creep driving that the vehicle 10 is drives and accelerates at the predetermined threshold speed or less, the determined target acceleration may indicate forward direction (positive) creep torque. Accordingly, when the road gradient indicates an uphill slope, the correction coefficient is set to a value of 1 or above, and the determined target acceleration may be adjusted in the direction in which the absolute value increases.

Furthermore, when the vehicle 10 is in the creep driving that the vehicle 10 drives and decelerates at the predetermined threshold speed or above, the determined target acceleration may indicate reverse direction (negative) creep torque. Accordingly, when the road gradient indicates an uphill slope, the correction coefficient is set to a value of 1 or less, and the determined target acceleration may be adjusted in the direction in which the absolute value decreases.

Also, as illustrated in FIG. 7, the correction factor according to the gradient and the speed may be decreased in proportion to the road gradient at the predetermined threshold speed or less, and may be increased in proportion to the road gradient at the predetermined threshold speed or above so that the reverse component of the target acceleration determined in proportion to the road gradient may be increased when the road gradient indicates a downhill slope.

That is, when the vehicle 10 is in the creep driving that the vehicle 10 drives and accelerates at the predetermined threshold speed or less, the determined target acceleration may indicate the forward direction (positive) creep torque. Accordingly, when the road gradient indicates a downhill slope, the correction coefficient is set to a value of 1 or less, and the determined target acceleration may be adjusted in the direction in which the absolute value decreases.

Furthermore, when the vehicle 10 is in the creep driving that the vehicle 10 drives and decelerates at the predetermined threshold speed or above, the determined target acceleration may indicate the reverse direction (negative) creep torque. Accordingly, when the road gradient indicates a downhill slope, the correction coefficient is set to a value of 1 or above, and the determined target acceleration may be adjusted in the direction in which the absolute value increases.

Furthermore, the controller 140 may determine the creep torque based on the current speed of the vehicle 10 and the current gear ratio.

The controller 140 may determine the creep torque based on the information on the creep torque according to the speed and the gear ratio stored in the storage 150.

Referring to FIG. 8, the controller 140 may determine the forward direction (positive) creep torque so that the vehicle 10 accelerates when driving forward at the predetermined threshold speed or less (low speed) and determine a greater creep torque as the speed of the vehicle 10 decreases.

Furthermore, the controller 140 may determine the reverse direction (negative) creep torque so that the vehicle 10 decelerates when driving forward at the predetermined threshold speed or above (high speed). At the instant time, the creep torque may be decelerated in proportion to the speed of the vehicle 10 or exponentially up to the predetermined upper limit speed, and converged to the creep torque corresponding to the predetermined upper limit speed at a speed higher than the predetermined upper limit speed.

Furthermore, the controller 140 may determine the creep torque in consideration of the gear ratio in addition to the speed of the vehicle 10. The controller 140 may set the absolute value of the creep torque to be lower as the gear ratio becomes higher. Accordingly, in a situation where the gear ratio corresponds to the high gear ratio that desires the fast acceleration feeling, the deceleration feeling may be made lower than when the gear ratio is low.

The controller 140 may determine the creep torque before being updated based on the correlation information between the driving mode and the creep torque of the vehicle 10 stored in the storage 150 and the driving mode of the vehicle 10 set through the input unit 110.

That is, the storage 150 may store a table in which the creep torque for the same vehicle speed and the gear ratio is set differently according to the driving mode of the vehicle 10.

Each time the mode is switched to the economical mode, the normal mode, and the sports mode, the controller 140 may increase the creep torque for the same vehicle speed and the gear ratio based on the correlation information between the driving mode and the creep torque stored in the storage 150.

That is, the creep torque may be set to be higher than the normal mode in the sports mode, and the creep torque may be set to be lower than the normal mode in the economical mode.

Therefore, in the sports mode, the user may feel the acceleration feeling or deceleration feeling more rapidly when the creep driving is started by pressing the accelerator pedal or the brake pedal and removing the pressure. In the economical mode, the energy efficiency may be increased by decelerating or accelerating more slowly when the creep driving is started by pressing the accelerator pedal or the brake pedal and removing the pressure.

Furthermore, the controller 140 may determine the road gradient on which the vehicle 10 is driving based on the output value of the tilt sensor 124, and adjust the creep torque before being updated based on the determined gradient. That is, the controller 140 may adjust the creep torque determined according to the speed of the vehicle 10 and the gear ratio based on the road gradient before being updated based on the difference value between the target speed and the current speed.

The controller 140 may adjust the determined creep torque so that the forward component is increased in proportion to the road gradient when the road gradient indicates an uphill slope, and may adjust the determined creep torque so that the reverse component is increased in proportion to the road gradient when the road gradient indicates a downhill slope.

That is, the controller 140 may adjust the determined creep torque so that the forward component is increased to reach the target speed according to the target acceleration when the vehicle 10 drives uphill, and may adjust the determined creep torque so that the reverse component is increased to prevent the vehicle 10 from exceeding the target speed according to the target acceleration when the vehicle 10 drives downhill.

Also, the controller 140 may update the determined creep torque based on the difference value between the target speed according to the determined target acceleration and the current speed of the vehicle 10.

Referring to FIG. 9, the controller 140 may perform the PI control operation on the difference value between the target speed and the current speed of the vehicle 10 to determine an updated value, and may update the determined creep torque by summing the determined creep torque and the determined update value.

The controller 140 may determine the P gain and the I gain in the PI control operation based on the correlation information between the driving mode of the vehicle 10 stored in the storage 150 and the PI control and the driving mode of the vehicle 10 set through the input unit 110.

That is, the controller 140 may set the P gain and the I gain in the PI control operation differently according to the driving mode of the vehicle 10. The controller 140 may increase the P gain and the I gain each time the mode is switched to the economical mode, the normal mode, and the sports mode. That is, in the sports mode, the speed of the vehicle 10 may reach the target speed faster than in the normal mode, and in the economical mode, the speed of the vehicle 10 may reach the target speed more slowly than in the normal mode. As a result, the user may feel a faster speed change in the sports mode and energy efficiency according to a slow speed change in the economical mode.

The controller 140 may perform a disturbance observer (DOB) control operation in addition to the PI control operation to adjust the update value determined according to the PI control operation in the direction canceling the disturbance due to the DOB control operation.

The controller 140 may also adjust the sensitivity of the creep torque update by updating the determined creep torque when the difference value between the target speed and the current speed of the vehicle 10 is equal to or greater than a predetermined threshold value. At the instant time, the threshold value may be adjusted by the user through the input unit 110, and may be set in the design stage and stored in the storage 150.

Hereinafter, an exemplary embodiment of a control method of the vehicle 10 will be described. The vehicle 10 according to the above-described embodiment may be used as the control method of the vehicle 10. Therefore, the contents described above with reference to FIGS. 1 to 9 may be applied to the control method of the vehicle 10 as well.

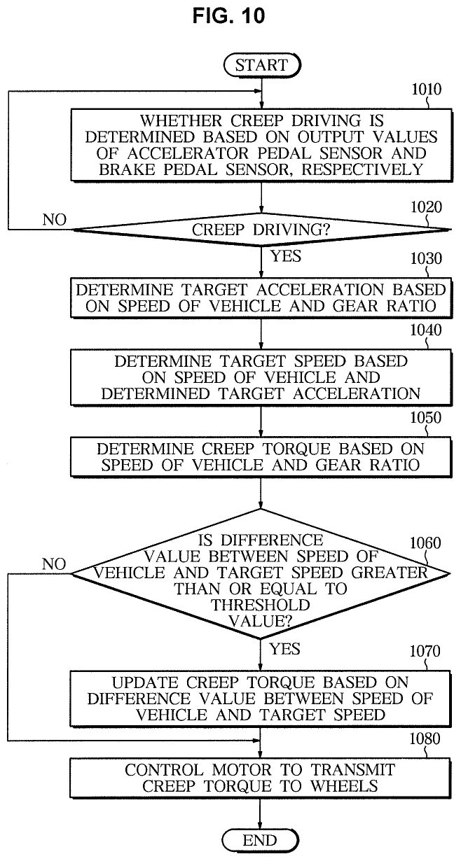

FIG. 10 is a flowchart illustrating a case in which the creep torque is updated during the creep driving in a vehicle control method according to an exemplary embodiment of the present invention.

Referring to FIG. 10, the controller 140 may determine whether the vehicle 10 is the creep driving based on the output values of the accelerator pedal sensor 122 and the brake pedal sensor 123, respectively (1010).

That is, when the output values of the accelerator pedal sensor 122 and the brake pedal sensor 123 correspond to “0,” that is, when the user of the vehicle 10 does not press the accelerator pedal and the brake pedal, the controller 140 may determine that the vehicle 10 satisfies the creep driving condition and is in the creep driving state.

The controller 140 may determine the target acceleration based on the speed of the vehicle 10 and the gear ratio when the vehicle 10 is the creep driving state (YES in 1020) (1030).

That is, the controller 140 may determine the target acceleration for determining the target speed to be compared with the current speed. The controller 140 may determine the target acceleration based on the current speed of the vehicle 10 and the gear ratio of the transmission 130.

To the present end, the target acceleration according to the speed of the vehicle 10 and the gear ratio may be preset and stored in the storage 150. That is, information on the target acceleration according to the speed of the vehicle 10 and the gear ratio may be stored in the storage 150 in a form of a table.

At the instant time, below the predetermined threshold speed, the target acceleration in the forward direction (positive) may be preset so that the vehicle 10 accelerates when driving forward thereof. Above the predetermined threshold speed, the target acceleration in the reverse direction (negative) may be preset so that the vehicle 10 decelerates when driving forward thereof. At the instant time, the target acceleration may be decelerated in proportion to the speed of the vehicle 10 or exponentially up to a predetermined upper limit speed, and converged to the target acceleration corresponding to the predetermined upper limit speed at a speed higher than the predetermined upper limit speed.

That is, as the current speed of the vehicle 10 is increased, the absolute value of the target acceleration in the reverse direction (negative) may become larger. Thus, when the vehicle 10 enters the creep driving state in a state where the current speed of the vehicle 10 is fast, the user of the vehicle 10 may feel a greater deceleration feeling.

The information on the target acceleration according to the speed of the vehicle 10 and the gear ratio may be set such that the absolute value of the target acceleration in the reverse direction (negative) for deceleration becomes lower as the gear ratio increases. Therefore, in a situation where the gear ratio corresponds to the high gear ratio that desires the fast acceleration feeling, the deceleration feeling may be made lower than in the case of the lower gear ratio.

The controller 140 may also determine the target acceleration based on the correlation information between the driving mode of the vehicle 10 and the target acceleration and the driving mode of the vehicle 10.

The storage 150 may store correlation information between the driving mode of the vehicle 10 and the target acceleration. The storage 150 may store information on the target acceleration according to the speed and the gear ratio for each driving mode of the vehicle 10. The controller 140 may determine information on the target acceleration according to the corresponding speed and the gear ratio based on the driving mode of the vehicle 10 and determine the target acceleration corresponding to the current speed and the current gear ratio based on the determined information related to the target acceleration.

At the instant time, the absolute value of the target acceleration may be set larger in the sports mode than in the normal mode, and the absolute value of the target acceleration may be set smaller in the economical mode than in the normal mode. Thus, in the sports mode, a greater acceleration feeling or deceleration feeling may be felt when the creep driving is entered according to the operation of the accelerator pedal and the brake pedal, and the user may feel a more dynamic driving feeling. Also, in the economical mode, the energy efficiency may be improved by setting the width of speed change to be lower when entering creep driving than in the normal mode.

The controller 140 may also control the communicator 170 to receive at least one of the road traffic information related to the road on which the vehicle 10 is driving from the external server and the weather information related to the area where the vehicle 10 is located.

The controller 140 may adjust the target acceleration determined by the current speed and the current gear ratio based on at least one of the road traffic information and the weather information obtained from the external server through the communicator 170.

For example, the target acceleration determined according to the type of road designated by the road traffic information may be adjusted. The type of road may include highways, national roads, and city roads. The controller 140 may adjust the absolute value of the target acceleration higher than the absolute value of the target acceleration on national roads when the type of the road corresponds to highways. The controller 140 may adjust the absolute value of the target acceleration lower than the absolute value of the target acceleration on national roads when the type of the road corresponds to city roads.

Furthermore, the controller 140 may adjust the target acceleration determined based on the current speed and the current gear ratio according to the degree of road congestion included in the road traffic information. That is, the controller 140 may adjust the absolute value of the target acceleration determined as the road congestion becomes higher.

Furthermore, the controller 140 may adjust the determined target acceleration to a low level when the weather in the area where the vehicle 10 designated by the weather information corresponds to snow or rain. Accordingly, the vehicle 10 may ensure safe driving even when the vehicle 10 enters the creep driving under snowy or rainy conditions.

Furthermore, the controller 140 may adjust the target acceleration determined according to the current speed and the current gear ratio according to the road gradient on which the vehicle 10 is driving.

The controller 140 may adjust the determined target acceleration so that the forward component is increased in proportion to the road gradient when the road gradient indicates an uphill slope, and may adjust the determined target acceleration so that the reverse component is increased in proportion to the road gradient when the road gradient indicates a downhill slope.

That is, the controller 140 may prevent the vehicle 10 from being slowed differently than intended by adjusting the target acceleration determined so that the target acceleration is increased in the positive direction when the vehicle 10 drives uphill. The controller 140 may prevent the vehicle 10 from being accelerated differently than intended by adjusting the target acceleration determined so that the target acceleration is increased in the negative direction when the vehicle 10 drives downhill.

The controller 140 may determine the target speed based on the speed of the vehicle 10 and the determined target acceleration (1040). The controller 140 may determine the target speed by adding the value obtained by the current acceleration of the vehicle 10 multiplied by the target acceleration and the predetermined time section.

The controller 140 may determine the creep torque based on the speed of the vehicle 10 and the gear ratio.

The controller 140 may determine the creep torque based on the information on the creep torque according to the speed and the gear ratio stored in the storage 150.

That is, the controller 140 may determine the forward direction (positive) creep torque so that the vehicle 10 accelerates when driving forward at the predetermined threshold speed or less (low speed) and determine a greater creep torque as the speed of the vehicle 10 decreases.

Furthermore, the controller 140 may determine the reverse direction (negative) creep torque so that the vehicle 10 decelerates when driving forward at the predetermined threshold speed or above (high speed). At the instant time, the creep torque may be decelerated in proportion to the speed of the vehicle 10 or exponentially up to the predetermined upper limit speed, and converged to the creep torque corresponding to the predetermined upper limit speed at a speed higher than the predetermined upper limit speed.

Furthermore, the controller 140 may determine the creep torque in consideration of the gear ratio in addition to the speed of the vehicle 10. The controller 140 may set the absolute value of the creep torque to be lower as the gear ratio becomes higher. Accordingly, in a situation where the gear ratio corresponds to the high gear ratio that desires the fast acceleration feeling, the deceleration feeling may be made lower than when the gear ratio is low.

In a situation where the gear ratio corresponds to the high gear ratio that desires the fast acceleration feeling

The controller 140 may determine the creep torque before being updated based on the correlation information between the driving mode and the creep torque of the vehicle 10 stored in the storage 150 and the driving mode of the vehicle 10 set through the input unit 110.

That is, the storage 150 may store a table in which the creep torque for the same vehicle speed and the gear ratio is set differently according to the driving mode of the vehicle 10.

Each time the mode is switched to the economical mode, the normal mode, and the sports mode, the controller 140 may increase the creep torque for the same vehicle speed and the gear ratio based on the correlation information between the driving mode and the creep torque stored in the storage 150.

That is, the creep torque may be set to be higher than the normal mode in the sports mode, and the creep torque may be set to be lower than the normal mode in the economical mode.

Therefore, in the sports mode, the user may feel the acceleration feeling or deceleration feeling more rapidly when the creep driving is started by pressing the accelerator pedal or the brake pedal and removing the pressure. In the economical mode, the energy efficiency may be increased by decelerating or accelerating more slowly when the creep driving is started by pressing the accelerator pedal or the brake pedal and removing the pressure.

Furthermore, the controller 140 may determine the road gradient on which the vehicle 10 is driving based on the output value of the tilt sensor 124, and adjust the creep torque before being updated based on the determined gradient. That is, the controller 140 may adjust the creep torque determined according to the speed of the vehicle 10 and the gear ratio based on the road gradient before being updated based on the difference value between the target speed and the current speed.

The controller 140 may adjust the determined creep torque so that the forward component is increased in proportion to the road gradient when the road gradient indicates an uphill slope, and may adjust the determined creep torque so that the reverse component is increased in proportion to the road gradient when the road gradient indicates a downhill slope.

That is, the controller 140 may adjust the determined creep torque so that the forward component is increased to reach the target speed according to the target acceleration when the vehicle 10 drives uphill, and may adjust the determined creep torque so that the reverse component is increased to prevent the vehicle 10 from exceeding the target speed according to the target acceleration when the vehicle 10 drives downhill.

The controller 140 may update the creep torque based on the difference value between the speed of the vehicle 10 and the target speed when the difference value between the speed of the vehicle 10 and the target speed is equal to or greater than the threshold value (YES in 1060) (1070).

The controller 140 may perform the PI control operation on the difference value between the target speed and the current speed of the vehicle 10 to determine an updated value, and may update the determined creep torque by summing the determined creep torque and the determined update value.

The controller 140 may determine the P gain and the I gain in the PI control operation based on the correlation information between the driving mode of the vehicle 10 stored in the storage 150 and the PI control and the driving mode of the vehicle 10 set through the input unit 110.

That is, the controller 140 may set the P gain and the I gain in the PI control operation differently according to the driving mode of the vehicle 10. The controller 140 may increase the P gain and the I gain each time the mode is switched to the economical mode, the normal mode, and the sports mode. That is, in the sports mode, the speed of the vehicle 10 may reach the target speed faster than in the normal mode, and in the economical mode, the speed of the vehicle 10 may reach the target speed more slowly than in the normal mode. As a result, the user may feel a faster speed change in the sports mode and energy efficiency according to a slow speed change in the economical mode.

The controller 140 may perform a disturbance observer (DOB) control operation in addition to the PI control operation to adjust the update value determined according to the PI control operation in the direction canceling the disturbance due to the DOB control operation.

The controller 140 may also adjust the sensitivity of the creep torque update by updating the determined creep torque when the difference value between the target speed and the current speed of the vehicle 10 is equal to or greater than a predetermined threshold value. At the instant time, the threshold value may be adjusted by the user through the input unit 110, and may be set in the design stage and stored in the storage 150.

The controller 140 may control the motor 160 to transmit the creep torque to the wheel (1080). At the instant time, the creep torque transmitted from the motor 160 to the wheel based on the control of the controller 140 may correspond to the determined creep torque based on the speed of the vehicle 10 and the gear ratio, depending on the difference value between the speed of the vehicle 10 and the target speed and the magnitude of the threshold value, and may correspond to the updated creep torque based on the difference value between the speed of the vehicle 10 and the target speed. In the present way, the vehicle 10 may provide the creep driving with constant deceleration or acceleration even when the driving load is varied.

As is apparent from the above description, the exemplary embodiments of the present invention may provide a consistent deceleration feeling or acceleration feeling during the creep driving even when the driving load of the vehicle is changed by determining the creep torque based on the target acceleration of the vehicle.

Meanwhile, the exemplary embodiments of the present invention may be implemented in a form of recording media for storing instructions to be conducted by a computer. The instructions may be stored in a form of program codes, and when executed by a processor, may generate program modules to perform operations in the exemplary embodiments of the present invention. The recording media may correspond to computer-readable recording media.

The computer-readable recording medium may include any type of recording medium having data stored thereon which may be thereafter read by a computer. For example, it may be a ROM, a RAM, a magnetic tape, a magnetic disk, a flash memory, an optical data storage device, etc.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A vehicle comprising:
a motor;
a transmission coupled to the motor;
a vehicle speed sensor configured to detect a speed of the vehicle; and
a controller connected to the vehicle speed sensor and configured to determine a target acceleration and a creep torque based on a current speed of the vehicle and a gear ratio of the transmission when the vehicle satisfies a creep driving condition, update a determined creep torque based on a difference value between a target speed according to a determined target acceleration and the current speed of the vehicle, and control the motor to transmit an updated creep torque to wheels of the vehicle.

2. The vehicle according to claim 1,
wherein the controller is configured to update a reverse component of the determined creep torque to be higher in proportion to the difference value when the target speed is lower than the current speed of the vehicle and
wherein the controller is configured to update a forward component of the determined creep torque to be higher in proportion to the difference value when the target speed is higher than the current speed of the vehicle.

3. The vehicle according to claim 2,
wherein the controller is configured to determine an update value by performing a proportional-integral (PI) control operation on the difference value between the target speed and the current speed of the vehicle and update the determined creep torque by summing the determined creep torque and a determined update data.

4. The vehicle according to claim 3,
wherein the controller is configured to determine a P gain and an I gain in the PI control operation based on correlation information between a driving mode of the vehicle and the PI control operation and the driving mode of the vehicle.

5. The vehicle according to claim 3,
wherein the controller is configured to adjust the update value in a direction cancelling a disturbance due to a disturbance observer (DOB) control operation.

6. The vehicle according to claim 1, wherein the controller is configured to update the determined creep torque when the difference value between the target speed and the current speed of the vehicle is equal to or greater than a predetermined threshold value.

7. The vehicle according to claim 1, wherein the controller is configured to determine the creep torque based on correlation information between a driving mode of the vehicle and the creep torque and the driving mode of the vehicle.

8. The vehicle according to claim 1, wherein the controller is configured to determine the target acceleration based on correlation information between a driving mode of the vehicle and the target acceleration and the driving mode of the vehicle.

9. The vehicle according to claim 1, further including:
a communicator connected to the controller and configured to perform communication with an external server,
wherein the controller is configured to control the communicator to receive at least one of road traffic information related to a road on which the vehicle is driving from the external server and weather information related to an area where the vehicle is located, and adjust the determined target acceleration based on at least one of the road traffic information and the weather information.

10. The vehicle according to claim 1, further including:
a tilt sensor connected to the controller and configured to detect a tilt of the vehicle,
wherein the controller is configured to determine a gradient of a road on which the vehicle is driving based on an output value of the tilt sensor, adjust at least one of the determined creep torque and the determined target acceleration so that a forward component of the determined creep torque is increased in proportion to the gradient when the gradient indicates an uphill slope, and adjust at least one of the determined creep torque and the determined target acceleration so that a reverse component of the determined creep torque is increased in proportion to the gradient when the gradient indicates a downhill slope.

11. A method for controlling a vehicle which includes a motor, a transmission, and a vehicle speed sensor detecting a speed of the vehicle, the method comprising:
determining, by a controller connected to the vehicle speed sensor, a target acceleration and a creep torque based on a current speed of the vehicle and a gear ratio of the transmission when the vehicle satisfies a creep driving condition;
updating, by the controller, a determined creep torque based on a difference value between a target speed according to a determined target acceleration and the current speed of the vehicle; and
controlling, by the controller, the motor to transmit an updated creep torque to wheels of the vehicle.

12. The method according to claim 11, wherein the updating of the determined creep torque includes:
updating a reverse component of the determined creep torque to be higher in proportion to the difference value when the target speed is lower than the current speed of the vehicle; and
updating a forward component of the determined creep torque to be higher in proportion to the difference value when the target speed is higher than the current speed of the vehicle.

13. The method according to claim 12, wherein the updating of the determined creep torque includes:
determining an update value by performing a proportional-integral (PI) control operation on the difference value between the target speed and the current speed of the vehicle; and
updating the determined creep torque by summing the determined creep torque and a determined update data.

14. The method according to claim 13, wherein the updating of the determined creep torque includes:
determining a P gain and an I gain in the PI control operation based on correlation information between a driving mode of the vehicle and the PI control and the driving mode of the vehicle.

15. The method according to claim 13, wherein the updating of the determined creep torque includes:
adjusting the update value in a direction cancelling a disturbance due to a disturbance observer (DOB) control operation.

16. The method according to claim 11, wherein the updating of the determined creep torque includes:
updating the determined creep torque when the difference value between the target speed and the current speed of the vehicle is equal to or greater than a predetermined threshold value.

17. The method according to claim 11, wherein the determining of the creep torque includes:
determining the creep torque based on correlation information between a driving mode of the vehicle and the creep torque and the driving mode of the vehicle.

18. The method according to claim 11, wherein the determining of the target acceleration includes:
determining the target acceleration based on correlation information between a driving mode of the vehicle and the target acceleration and the driving mode of the vehicle.

19. The method according to claim 11,
wherein the vehicle further includes a communicator connected to the controller and configured to perform communication with an external server, and
wherein the method further including:
controlling the communicator to receive at least one of road traffic information related to a road on which the vehicle is driving from the external server and weather information related to an area where the vehicle is located; and
adjusting the determined target acceleration based on at least one of the road traffic information and the weather information.

20. The method according to claim 11,
wherein the vehicle further includes a tilt sensor connected to the controller and configured to detect a tilt of the vehicle, and
wherein the method further including:
determining, by the controller, a gradient of a road on which the vehicle is driving based on an output value of the tilt sensor;
adjusting, by the controller, at least one of the determined creep torque and the determined target acceleration so that a forward component of the determined creep torque is increased in proportion to the gradient when the gradient indicates an uphill slope; and
adjusting, by the controller, at least one of the determined creep torque and the determined target acceleration so that a reverse component of the determined creep torque is increased in proportion to the gradient when the gradient indicates a downhill slope.
